(19) United States
(12) Patent Application Publication
(10) Pub. No.: US 2022/0219596 A1
(43) Pub. Date: Jul. 14, 2022

(54) LOAD COVERING APPARATUS AND METHODS OF USE

(71) Applicant: David Elniski, Lethbridge (CA)

(72) Inventor: David Elniski, Lethbridge (CA)

(21) Appl. No.: 17/517,402

(22) Filed: Nov. 2, 2021

Related U.S. Application Data
(60) Provisional application No. 63/136,036, filed on Jan. 11, 2021.

(51) Int. Cl. B60P 7/08

(52) U.S. Cl. CPC B60P 7/0853; B60P 7/0869; B60P 7/0876

(57) ABSTRACT

The present apparatus and methods of use are directed to covering a load being transported or stored on a storage site. The apparatus comprises at least one carrier component operative to carry at least one cover over the load as the carrier and the cover are pulled over the load. As a first option, the present apparatus may comprise at least one manipulator device component operative to manipulate the carrier component and other components. As a second option, the present apparatus may comprise at least one edge cap component operative to provide for more efficient pulling of the carrier and the cover over corners or edges of the load. Advantageously, the present apparatus may be configured as a kit that can be conveniently transported by an operator and safely used by the operator from ground level.

### CROSS-REFERENCE TO RELATED APPLICATIONS

This patent application claims the benefit of U.S. Provisional Patent Application No. 63/136,036, filed on Jan. 11, 2021, which is specifically incorporated by reference herein for all that it discloses or teaches.

### FIELD OF USE

Embodiments herein relate generally to apparatus and methods of use for covering a load being transported or stored on a storage site and specifically to apparatus and methods of use for covering a load on a truck bed, trailer deck, railcar deck, water vessel hold, aircraft hold, pallet, shelf, or storage site.

### BACKGROUND

Apparatus and methods of use for covering loads are well known in the art. Vehicles such as trucks, trailers, railcars, water vessels, and aircraft are often used to transport loads including palleted goods, boxed goods, goods with irregular shapes, bagged goods, and bundled goods. It is both desirable and required by regulatory bodies to ensure that such loads are secured during transport and while located at storage sites. Securing such loads can prevent the loads or components thereof from becoming dislodged and causing property damage or bodily injury.

Loads are typically secured for transport or storage using a variety of methods such as straps, ropes, or cords. Such methods are limited, however, where the load has multiple containers of different sizes and shapes, or where the load is difficult to contain (e.g., hay bales, or other loose materials). Often, additional components such as tarpaulins, plastic wrap, or canvas sheets are also required to secure the load properly, as well as to protect the load from adverse weather conditions including rain and snow. For example, a tarpaulin can first be wrapped over the load and then secured to the vehicle or storage site with straps. Although it is possible to utilize tarpaulins, plastic wrap, or canvas sheets in this manner, covering the load quickly becomes complicated and even dangerous, particularly where the operator needs to climb up onto the load in order to secure the cover, straps, etc. in place. Indeed, federal statutes and provincial legislation in Canada prohibits operators from working at heights over 3 meters (approximately 10 feet) without safety equipment to prevent falls, while federal and state laws in the United States prohibit operators from working at heights over 1.2 to 2.4 meters (4 to 8 feet) depending on the industry.

For instance, many loads are covered manually by the operator, where the operator climbs up and over the load to drag the cover into position. The operator will then throw one or more straps over the covered load and fix the ends of the straps to a suitable base such as a truck bed to secure both the load and the cover in place. Unfortunately, loads can often exceed many metres in height, posing a serious safety risk for the operator and triggering legislated safety requirements. Furthermore, irregularly shaped loads or loads with sharp corners may be very difficult to climb and may further catch or snag the cover, straps, etc. as the load is being covered.

Attempts have been made to develop safer and more efficient ways to cover loads. One known methodology comprises using a fall restraint system such as a harness, or the like, to reduce the risk of falling. The operator will first typically climb the load before securing themself to the top of the load with the fall restraint system, and then cover the load before disengaging from the system and climbing down from the load. Known fall restraint systems may be mounted to the load or an external mounting device. Such systems are problematic, however, because they still require the operator to climb up on to the load and down off the load, typically while the fall restraint system is disengaged, which fails to eliminate the risk of falling entirely.

Another known methodology comprises using a building structure or scaffold that is positioned adjacent to the load. The operator will climb the structure or scaffold instead of the load itself and then use the improved vantage point to position the cover over the load, either by hand or with the assistance of a mechanical device. Most building structures or scaffolds used for covering loads have handrails, harnesses, or other safety-improving tools that serve to reduce the risk of falling. Such systems, however, are large, expensive, and generally immobile installations that cannot be available in every location that a load may need to be covered. Such systems are also problematic because the risk of falling is still not eliminated entirely, especially during ascent and decent where the safety-improving tools may need to be disengaged to allow for operator mobility.

Yet another known methodology comprises using an adapted forklift to lift and position the cover above the load. The cover is then released from the forklift and secured to a suitable base such as a truck bed from ground level. Although this methodology eliminates the risk of falling and is more widely available in locations without dedicated building structures or scaffolds, it still requires an adapted forklift and for operators to have special training and qualifications to operate the adapted forklift. Also, adapted forklifts may not be available in every location that a load needs to be covered, e.g., at the roadside where the cover has inadvertently blown from the load.

Yet another known methodology comprises using a pulley system that can be controlled by the operator from the ground. The pulley system requires that at least one pulley wheel and corresponding pull ropes be mounted vertically above the load. While pulley systems may allow operators to safely cover a load from ground level in locations where dedicated installations and forklifts are not available, they nonetheless suffer from several limitations. Such systems are complicated to assemble and disassemble for each use and require sufficient headroom above the load. Pulley systems are bulky and heavy, making them undesirable to stow during transport. The size and weight of pulley systems can impact the overall weight of the cargo, fuel efficiency, and load efficiency. For example, given that trucks, trailers, railcars, and aircraft are subject to weight limits, any additional weight stowed with the load and/or vehicle necessarily reduces the load-carrying capacity of the vehicle. Furthermore, automated pulley systems can malfunction due to operator error or equipment failure, potentially leading to the pulley posing a safety hazard.

There remains a need for an improved load covering apparatus and methods of using the apparatus to cover loads for transportation and/or storage.

### SUMMARY

According to embodiments, an improved apparatus and methods of use for covering a load with at least one cover are provided. More specifically, the present apparatus comprises at least one tubular carrier for carrying the cover, the carrier having a first end, a second end, and a sidewall forming at least one pair of diametrically opposed apertures, at least one pull strap, slidably received within the pair of apertures, and at least one connector, supported by the pull strap, for reversible connection to the cover, wherein a pulling force applied to the pull strap pulls the carrier and the cover over the load.

In some embodiments, the present apparatus further comprises at least one manipulator device. The manipulator device may comprise a head portion releasably connected to a handle portion, the head portion comprising a main body forming a plurality of protruding flanges, wherein the plurality of protruding flanges may comprise at least two upwardly extending flanges forming a u-shaped groove, a first laterally extending flange protruding upwardly, and a second laterally extending flange protruding downwardly. In some embodiments, the main body may comprise at least one plate extending outwardly and forming a slot therebetween.

In other embodiments, the present apparatus may comprise at least one edge cap. The edge cap may form an angled sidewall having a convex outer surface and at least one opening.

In yet other embodiments, the present apparatus may be housed within a container. Advantageously, the container containing the present apparatus may have a total carrying weight of no greater than about forty kilograms (40 kg).

The present methods may comprise providing at least one tubular carrier for carrying the cover, the carrier having a first end, a second end, and a sidewall forming at least one pair of diametrically opposed apertures, providing at least one pull strap slidably received within the at least one pair of diametrically opposed apertures, and applying a pulling force to the at least one pull strap to pull the at least one tubular carrier and the at least one cover over the load.

In some embodiments, the present methods may comprise providing at least one manipulator device for reversibly engaging the load, cover, carrier, or pull strap to assist the carrier and the cover over the load. The length of the manipulator device may be adjustable.

In other embodiments, the present methods may comprise providing at least one edge cap and positioning the edge cap on at least one portion of the load. In such embodiments, the carrier and the cover may be pulled over the at least one edge cap. At least one manipulator device may be provided for reversibly engaging the at least one edge cap to assist the at least one carrier and the at least one cover over the load.

In yet other embodiments, the present methods may be performed by an operator positioned at ground level.

### BRIEF DESCRIPTION OF THE DRAWINGS

The present apparatus and methods of use will now be described having regard to the following figures, which are presented for the purpose of illustration only and are not intended to be limiting:

FIG. 1 is a schematic representation of the present apparatus for covering a load, according to embodiments;

FIG. 2 is a perspective view of the present apparatus shown in FIG. 1, according to embodiments;

FIG. 3 is a perspective view of a manipulator device, according to embodiments;

FIG. 4a is a perspective view of the manipulator device of FIG. 4A shown in alignment with the apparatus shown in FIG. 1, according to embodiments;

FIG. 4b is a perspective view of the manipulator device of FIG. 4A shown in further alignment with the apparatus shown in FIG. 1, according to embodiments;

FIG. 5 is a perspective view of an edge cap, according to embodiments; and

FIG. 6 is a perspective view of the edge cap of FIG. 5 shown in alignment with the manipulator device of FIG. 3.

### DETAILED DESCRIPTION OF INVENTION

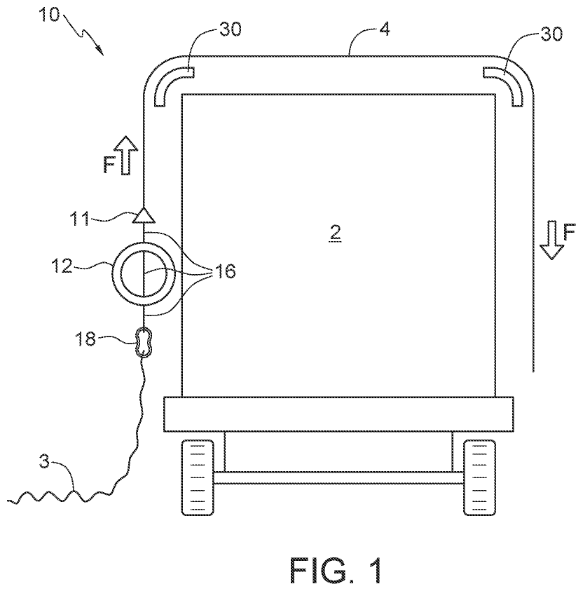

According to embodiments, an improved apparatus and methods of use for covering a load are provided. The improved apparatus comprises at least one carrier component operative to carry at least one cover over the load as the carrier and the cover are pulled over the load. Optionally, according to other embodiments, the improved apparatus may comprise at least one manipulator device component operative to lift, push, pull, manoeuvre, handle, or otherwise manipulate the carrier component and other moveable components (as will be described herein). In some embodiments, the length of the manipulator device may be adjusted. Optionally, according to yet other embodiments, the improved apparatus may comprise at least one edge cap component operative to provide for more efficient pulling of the carrier and the cover over corners or edges of the load. The improved apparatus and methods of use will now be described in more detail having regard to FIGS. 1-6.

Herein, the term ‘load’ means any form or type of cargo that may be transported by sea, air, or inland transportation by any vehicles or vessels including, without limitation, trucks, trailers, railcars, water vessels, and aircraft, and/or stored at a storage site.

Herein, the term “base” means any platform or vehicle that is suitable for receiving a load including, without limitation, a truck bed, trailer deck, railcar deck, water vessel hold, aircraft hold, pallet, shelf, or ground area.

Herein, the term ‘cover’ means any suitable material for use in covering, sealing, and/or protecting a load including, without limitation, a tarpaulin, plastic wrap, or canvas sheet, wherein the cover may form at least one corresponding connection means enabling the cover to be secured to and carried or pulled over the load by the present apparatus.

Having regard to FIG. 1, the present apparatus 10 and methods of use for covering a load 2 are provided, the apparatus 10 comprising at least one carrier component 12 for carrying at least one cover 3 over the load 2. Advantageously, apparatus 10 may be used (and methods of using apparatus 10 may be performed) from the ground level, preventing the operator from having to climb onto the load 2 and mitigating any risk related thereto. In some embodiments, the present apparatus 10 may further comprise a manipulator device component 20, and/or at least one edge cap component 30.

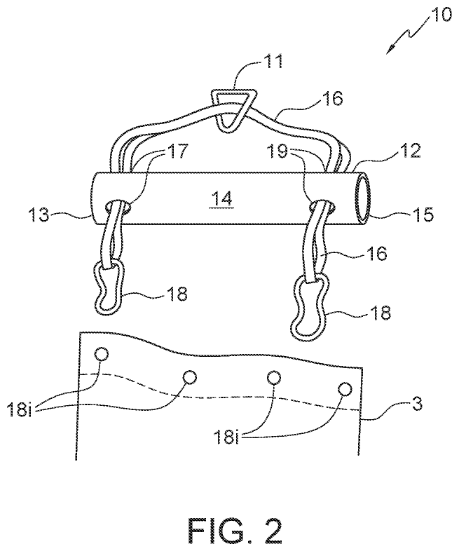

According to embodiments, carrier 12 may be specifically designed to reduce both the time and effort required by the operator to cover the load 2. For example, carrier 12 may be configured for simple connection with at least one cover 3 wherein, once connected, carrier 12 and cover 3 can be readily pulled over the load 2. Carrier 12 may also be configured for connection to, and use with, any cover 3 regardless of the size, shape, and material of the cover 3. For example, having regard to FIG. 2, carrier 12 may comprise an elongate tubular portion having first and second ends 13,15, respectively, and a substantially cylindrical sidewall 14. Advantageously, the outer surface of sidewall 14 may be sufficiently rounded and low-friction to enable easy movement of carrier 12 over the load 2. For example, where load 2 includes comprise uneven edges or corners, the convex curvature and/or smooth finish of the outer surface of sidewall 14 may enable carrier 12 to roll or pass over such edges or corners without difficulty, thereby carrying cover 3 over load 2. As a further advantage, the carrier 12 may have a length of less than approximately one metre (1 m) to enable convenient storage and provide a lightweight, easy-to-use component.

Carrier 12 may be manufactured from any lightweight material such as, without limitation, plastic, polyvinyl chloride (PVC), metal, or the like. For example, the material may have a smooth, low-friction finish. In some embodiments, carrier 12 may be construed to form a hollow central bore, or in any other form to provide a lightweight, easy-to-use component.

Carrier 12 may be configured to receive and secure means for pulling carrier 12 and cover 3 over the load 2. For example, having regard to FIG. 2, at or near each first and second end, 13,15, carrier 12 may form at least one pair of diametrically opposed apertures 17,19, extending through sidewall 14 for receiving and securing a pull strap 16 therethrough for pulling carrier 12 and cover 3. That is, when pulled upon, pull strap 16 serves to mobilize carrier 12 and cover 3 over the load 2. Apertures 17,19 may be any size, shape, and number to enable the slidable passage of pull strap 16 therethrough to ensure ease of porting carrier 12. Apertures 17,19 may also have any spacing or be positioned at any appropriate location along sidewall 14. It is understood that any means known in the art for securing a pull strap 16 to the carrier 12 are contemplated, including, without limitation, the use of common fasteners such as rivets, screws, nuts and bolts, glue, and the like.

Pull strap 16 may be manufactured from any heavy-duty, non-elastic material of sufficient strength and durability to pull the carrier 12 and cover 3. In some embodiments, pull strap 16 may comprise a strip of material having a first end for extending through first aperture 17 and a second end for extending through second aperture 19. At each end, pull strap 16 may be configured to receive and support at least one connector(s) 18 for releasably engaging corresponding connection means of cover 3 (e.g., apertures 18i; FIG. 2). Connector(s) 18 may comprise, without limitation, any appropriate form of hook, loop, D-ring, carabineer, tie, strap, or the like for engaging the corresponding connection means of cover 3 (as will be described herein).

It is an advantage of the present apparatus 10 that the at least one connector(s) 18 may further be sized so as to prevent pull strap 16 from disengaging apertures 17,19, preventing risk of pull strap 16 becoming tangled during stowage of apparatus 10. It should be appreciated that the presently described pull strap 16 and connectors 18 are for illustrative purposes only and that any other appropriate and adequate means for releasably securing carrier 12 to cover 3 are contemplated.

Optionally, pull strap 16 may be further manufactured to slidably receive means for securing pulling of the strap 16 over the load. For example, having regard to FIG. 2, pull strap 16 may comprise at least one pull strap suspender 11. In some embodiments, suspender 11 may be used to lift pull strap 16, rather than engaging strap 16 directly. For example, when desired, operator may apply sufficient pulling force to pull strap suspender 11 (‘F’; FIG. 1), causing pull strap 16 to become taught and initiating movement of carrier 12 and cover 3.

In some embodiments, suspender 11 may be manufactured of any material sufficient to withstand pulling force F imposed thereon, i.e., sufficiently strong material to at least support the weight of pull strap 16, carrier 12, and cover 3 during travel over the load 2.

It is contemplated that the pulling force F is applied from an opposite or otherwise adjacent side of the load 2 from the carrier 12 and cover 3. For example, having regard to FIG. 1, operator may manually pull a rope 4 or operate a pulling system (e.g., a mechanical, electrical, or otherwise motorized pulling system, etc.) to pull carrier 12 and cover 3 over the load 2.

That is, in use, the present apparatus 10 may be positioned at or near the base of a load 2 to be covered, such as at ground level on a first side of the load 2. Carrier 12 may be connected to cover 3 via connectors 18 (e.g., attached via corresponding apertures 18i), and to a pulling mechanism 4 via suspender 11 on pull strap 16. Once connected, operator may engage pulling mechanism 4, applying pulling force F to suspender 11 and then in turn to pull strap 16, carrier 12 and cover 3. The pulling force F will thereby mobilize cover 3 and enable the operator to position cover 3 over the load 2.

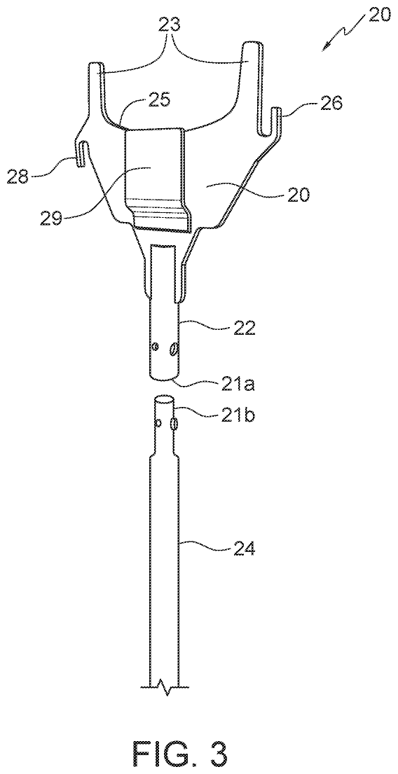

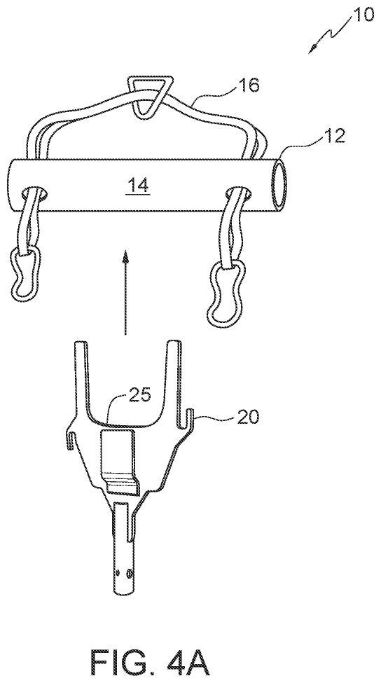

As above, in some embodiments, the present apparatus 10 may further comprise a manipulator device 20, and/or at least one edge cap 30. For example, having regard to FIGS. 3, 4A and 4B, the present manipulator device 20 may be used as desired and/or necessary to assist operator in pulling carrier 12 and cover 3 over the load 2. Manipulator device 20 may be manufactured from any lightweight material such as, without limitation, plastic, polyvinyl chloride (PVC), metal, or the like.

In some embodiments, manipulator 20 may comprise head portion 22 and a handle portion 24, wherein the handle portion 24 may be releasably connected to head portion 22. For example, a lower end of the head portion 22 may be configured to form a female receiving end 21a for operably receiving a corresponding male end 21b of the handle portion 24. Head 22 and handle 24 may be releasably connected via a spring-biased pin connection therebetween, or in any other appropriate manner as may be known in the art. It is contemplated that handle 24 may be telescopically extendible to at least a plurality of increasing lengths (i.e., to assist operator in using the manipulator 20 at various heights along the load 2).

In some embodiments, handle 24 may comprise various independent segments, which can be selected by the operator and releasably connected via a spring-biased pin connection therebetween, or in any other appropriate manner as may be known in the art, to assist operator in using the manipulator 20 at increasing heights along the load 2. For example, it is contemplated that a set of handles 24 of various lengths may be used in connection with each other, the number and length of handles 24 being selected by the operator to assist operator in using the manipulator 20 at various heights along the load 2.

According to embodiments, head 22 may comprise main body portion having a plurality of protruding flanges, each flange forming a corresponding groove and/or slot with the body, as will now be described in more detail.

At an upper end of the body, head 22 may form at least two opposed, upwardly extending flanges 23 forming a U-shaped groove 25 therebetween. In some embodiments, U-shaped groove 25 may be correspondingly sized and shaped so as to receive carrier 12 therein. For example, where it is desired to manipulate the position of carrier 12, carrier 12 may be slidably positioned between flanges 26 and within groove 25 (FIGS. 4A and 4B). The operator may then use the handle to manipulate the carrier 12 as needed.

At each side of the body, head 22 may form at least two opposed, laterally extending flanges 26,28, a first laterally extending flange protruding upwardly 26 and a second laterally extending flange protruding downwardly 28. In some embodiments, laterally extending flanges 26,28 may be correspondingly sized and shaped so as to receive or to ‘hook’ sidewall 14 of carrier 12, edge cap 30, cover 3, and/or the load 2 (as will be described below). For example, where it is desired to manipulate the position of carrier 12 and/or edge cap 30, a first or second end 13,15 of sidewall 14 of carrier 12 may be slidably hooked by either flange 26,28.

At a front or back face of the body, head 22 may form at least one plate 29, the plate 29 extending outwardly from the body to form a slot therebetween. In some embodiments, plate 29 may be correspondingly sized and shaped so as to receive edge cap 30 (as will be described below). For example, where it is desired to manipulate the position of edge cap 30, plate 29 may be used to slidably hook cap 30. It should be understood that any of the foregoing flanges and/or plates may be used to push, pull, or otherwise manipulate the carrier 12, one or more edge caps 30, any straps or ropes, the cover 3, and/or the load 2, as desired or as needed. In this regard, the operator may use the manipulator device 20 to assist in covering the load 2 from the ground, eliminating the need for the operator to climb the load 2 (e.g., where straps or other componentry become snagged, stuck, or otherwise positioned incorrectly).

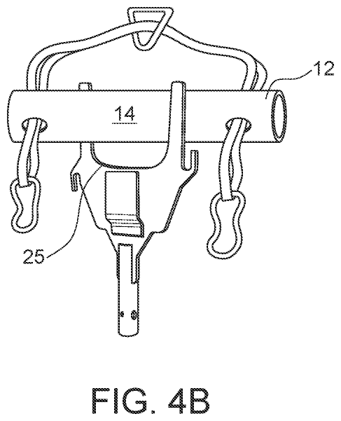

As also above, in some embodiments, the present apparatus 10 may further comprise at least one edge cap(s) 30. For example, having regard to FIG. 5, the at least one edge cap 30 may be used as desired and/or as necessary to assist operator in pulling carrier 12 and cover 3 over the load 2. Edge cap 30 may be manufactured to form an angled sidewall 31, the angle being of sufficient curvature to provide a convex ‘slide’ over protruding edges or corners of the load 2. Edge cap 30 may further be manufactured to form at least one opening 32. Opening 32 may be sized, shaped, and positioned for operably receiving any one of the flanges and/or plates protruding from the head 22 of manipulator device 20. Advantageously, edge cap 30 may have a length of less than approximately one metre (1 m), enabling convenient storage and providing a lightweight, easy-to-use component. Edge cap 30 may be manufactured from any lightweight material such as, without limitation, plastic, polyvinyl chloride (PVC), metal, or the like. Advantageously, the material may have a smooth, low-friction finish.

According to embodiments, methods of use of the present apparatus are also provided. In some embodiments, a load may be covered by at least one cover by providing at least one carrier for carrying the at least one cover over the load, suspending the carrier adjacent to the load with at least one pull strap, and applying a pulling force to the pull strap to pull the carrier and the cover over the load. In other embodiments, at least one manipulator device may be provided for manipulating the load, the cover, the pull strap, and an edge cap to enable the pulling of the carrier and the cover over the load. In yet other embodiments, at least one edge cap may be provided to cap corners or edges of the load.

Having regard to FIG. 1, apparatus 10 may be used to pull at least one cover 3 over the load 2 by providing one or more components that include at least one carrier 12, any number of manipulator devices 20, and any number of edge caps 30. It is an advantage of the present methods of use that the components of apparatus 10 may be provided in varying quantities as the configuration of cover 3 and load 2 may change from time to time. For example, if cover 3 is substantially longer than one carrier 12, it may be desirable to provide two or more carriers 12 that can be assembled and positioned in series relative to cover 3, as will be described in more detail herein. Conversely, if cover 3 is not substantially longer than one carrier 12, it may be desirable to provide only one carrier 12. As another example, if load 2 is an irregular shape comprising many edges and corners, it may be desirable to provide a plurality of manipulator devices 20 and edge caps 30 to assist in the mobilization of apparatus 10 and/or cover 3 over such edges and corners, as will be described in more detail herein. Conversely, if load 2 comprises few or no edges and corners, it may be desirable to provide one or no manipulator devices 20 and/or edge caps 30. The number of carriers 12, manipulator devices 20, and edge caps 30 that are desirable in respect of any particular configuration of cover 3 and load 2 may be readily appreciated.

In some embodiments, carriers 12, manipulator devices 20, and/or edge caps 30 may be assembled. For example, carriers 12 may receive at least one pull strap 16 that further supports at least one connector 18. Similarly, manipulator devices 20 can comprise a head portion 22 and handle portion 24 that may be connected together.

In yet other embodiments, carriers 12, manipulator devices 20, and/or edge caps 30 may be positioned relative to load 2 and cover 3 so that a pulling force F applied to carriers 12 can be used to pull cover 3 over load 2. Carriers 12 and cover 3 may be positioned adjacent to the base of load 2 on a first side of load 2, wherein connectors 18 may be used to conveniently engage corresponding connection means 18i of cover 3. If two or more carriers 12 and/or covers 3 are provided, they may be positioned in series along the first side of load 2 such that they extend along the whole length of the first side of load 2. Pulling force F may be provided by the operator or a pulling system positioned adjacent to the base of load 2 on a second side of load 2. A rope 4 may be positioned across load 2, wherein rope 4 can be connected to pull strap 16 on the first side of load 2 and the operator or pulling system on the second side of load 2. Advantageously, suspender 11 may be used to conveniently and resiliently connect rope 4 to pull strap 16. If two or more carriers 12 are provided, one rope 4 may be connected to the respective pull strap 16 received by each carrier 12 in turn or, alternatively, two or more ropes 4 may be connected to each respective pull strap 16 simultaneously.

In some embodiments, pulling force F may be applied to rope 4, wherein rope 4, pull strap 16, carriers 12, and cover 3 can be pulled over load 2. If two or more carriers 12 are provided, pulling force F may be applied via one rope 4 to each carrier 12 in turn or, alternatively, pulling force F may be applied via two or more ropes 4 to each carrier 12 simultaneously.

In yet other embodiments, rope 4, pull strap 16, and/or carriers 12 may be repositioned or stowed for transport after the cover 3 is positioned over load 2. It may be desirable to secure cover 3 to load 2 or a suitable base by providing and positioning straps or ropes as would be appreciated.

It is contemplated that manipulator devices 20 may be used to position the provided components of apparatus 10. In some embodiments, the manipulator devices 20 may be used to push carrier 12. Having regard to FIG. 4A and FIG. 4B, such embodiments may comprise inserting a carrier 12 into the U-shaped groove 25 of a manipulator device 20 and applying a pushing force through the handle 24 of the manipulator device 20. Similarly, such embodiments may comprise engaging an edge of carrier 12 with the laterally extending flange 26 of a manipulator device 20 and applying a pushing force through the handle 24 of the manipulator device 20. In other embodiments, the manipulator devices 20 may be used to pull carrier 12. Such embodiments may comprise engaging an edge of carrier 12 with the laterally extending flange 28 of a manipulator device 20 and applying a pulling force through the handle 24 of the manipulator device 20. It will be appreciated that manipulator devices 20 may be used in a similar manner to push or pull load 2, cover 3, rope 4, and other components of apparatus 10.

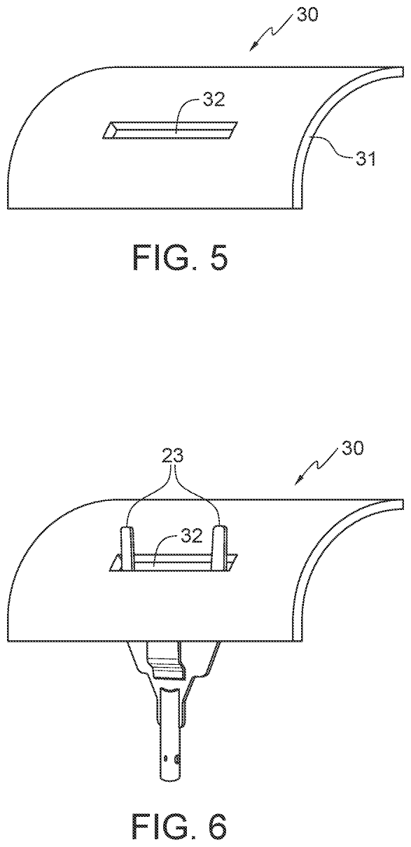

Optionally, edge caps 30 may be positioned at the edges and corners of load 2 to provide for more efficient pulling of the carrier 12 and cover 3 over load 2. In some embodiments, the manipulator devices 20 may be used to push edge caps 30 into position. Having regard to FIG. 6, such embodiments may comprise inserting the two upwardly extending flanges 23 of a manipulator device 20 into the opening 32 of an edge cap 30 and applying a pushing force through the handle 24 of the manipulator device 20. Similarly, such embodiments may comprise engaging an edge of an edge cap 30 with the laterally extending flange 26 of a manipulator device 20 and applying a pushing force through the handle 24 of the manipulator device 20. Such embodiments may also, or alternatively, comprise engaging an edge of an edge cap 30 with the plate 29 of a manipulator device 20 and applying a pushing force through handle 24 of the manipulator device 20. In other embodiments, the manipulator devices 20 may be used to pull edge caps 30 into position. Such embodiments may comprise engaging an edge of an edge cap 30 with the laterally extending flange 28 of a manipulator device 20 and applying a pulling force through the handle 24 of the manipulator device 20. As would be appreciated, the edge caps 30 may be secured to the load 2 using straps or ropes. It is an advantage of the present apparatus 10 that it may be packaged within a kit-type assembly for ease of storage and transport by the operator. For example, without limitation, the present apparatus 10 may be housed within a receptacle or container, such container being any appropriate rigid vessel such as a plastic tub, cardboard box, or the like, or a flexible vessel such as a duffel bag, tote bag, backpack, or the like. In some embodiments, the apparatus 10 may be packaged within a container so as to have a total volume of less than approximately 60 litres (60L) and less than approximately one metre (1 m) in length along each axis. In other embodiments, the apparatus 10 may have a total carrying weight of no greater than approximately 40 kilograms (40 kgs).

Herein, as would be appreciated by those skilled in the art, the present embodiments may be modified, amended, or configured without departing from the scope of the invention. The description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. An apparatus for covering a load with at least one cover, the apparatus comprising:
at least one tubular carrier for carrying the at least one cover, the at least one carrier having a first end, a second end, and a sidewall forming at least one pair of diametrically opposed apertures,
at least one pull strap, slidably received within the at least one pair of diametrically opposed apertures, and
at least one connector, supported by the at least one pull-strap, for reversible connection to the at least one cover,
wherein a pulling force applied to the at least one pull-strap pulls the at least one carrier and the at least one cover over the load.

2. The apparatus of claim 1, wherein the apparatus further comprises at least one manipulator device.

3. The apparatus of claim 2, wherein the at least one manipulator device comprises a head portion releasably connected to a handle portion.

4. The apparatus of claim 3, wherein the head portion comprises a main body forming a plurality of protruding flanges.

5. The apparatus of claim 4, wherein the plurality of protruding flanges comprise:
at least two upwardly extending flanges forming a u-shaped groove;
a first laterally extending flange protruding upwardly; and
a second laterally extending flange protruding downwardly.

6. The apparatus of claim 5, wherein the main body comprises at least one plate extending outwardly and forming a slot therebetween.

7. The apparatus of claim 1, wherein the apparatus further comprises at least one edge cap.

8. The apparatus of claim 7, wherein the at least one edge cap forms an angled sidewall having a convex outer surface.

9. The apparatus of claim 8, wherein the angled sidewall of the at least one edge cap forms at least one opening.

10. The apparatus of claim 1, wherein the apparatus is housed within a container.

11. The apparatus of claim 10, wherein the container containing the apparatus has a total carrying weight of no greater than about forty kilograms (40 kg).

12. A method of covering a load with at least one cover, the method comprising:
providing at least one tubular carrier for carrying the at least one cover, the carrier having a first end, a second end, and a sidewall forming at least one pair of diametrically opposed apertures;
providing at least one pull strap slidably received within the at least one pair of diametrically opposed apertures; and
applying a pulling force to the at least one pull strap to pull the at least one carrier and the at least one cover over the load.

13. The method of claim 12, further comprising providing at least one manipulator device for reversibly engaging at least one of the load, the cover, the carrier, or the pull strap to assist the carrier and the cover over the load.

14. The method of claim 13, wherein the length of the manipulator device may be adjustable.

15. The method of claim 12 further comprising:
providing at least one edge cap; and
positioning the at least one edge cap on at least one portion of the load.

16. The method of claim 15, wherein the at least one carrier and the at least one cover are pulled over the at least one edge cap.

17. The method of claim 15 or 16, further comprising providing at least one manipulator device for reversibly engaging the at least one edge cap to assist the at least one carrier and the at least one cover over the load.

18. The method of claim 12, wherein the method is performed by an operator positioned at ground level.
